(19) United States
(12) Patent Application Publication
(10) Pub. No.: US 2020/0324580 A1
(43) Pub. Date: Oct. 15, 2020

(54) Pneumatic Tire

(71) Applicant: The Yokohama Rubber Co., LTD., Minato-ku, Tokyo (JP)

(72) Inventor: Ryohei Takemori, Hiratsuka-shi, Kanagawa (JP)

(21) Appl. No.: 16/304,665

(22) PCT Filed: May 25, 2017
(86) PCT No.: PCT/JP2017/019603

§ 371 Date: Nov. 26, 2018

(30) Foreign Application Priority Data
May 26, 2016 (JP) 2016105168

(51) Int. Cl. B60C 13/00

(52) U.S. Cl. CPC B60C 13/001

(57) ABSTRACT

A pneumatic tire includes a tread section, a bead section, and a sidewall section. The sidewall section is provided in a predetermined region in a tire radial direction with: a first decorative section provided with a serration section including ridges protruding on an external surface of the sidewall section, the ridges being disposed adjacent to each other in a tire circumferential direction; a second decorative section disposed adjacent to an end portion of the first decorative section in the tire circumferential direction and being provided with a serration section including ridges protruding on the external surface, the ridges being disposed adjacent to each other in the tire circumferential direction; and a recessed section disposed adjacent to the second decorative section and being recessed inward from the second decorative section in the tire radial direction.

### TECHNICAL FIELD

The present technology relates to a pneumatic tire for mounting on a vehicle.

### BACKGROUND ART

Pneumatic tires for mounting on vehicles such as automobiles include a tire with a sidewall section having an external surface provided with a decorative section in which an emblem including characters and figures indicating a brand name and a size, and a pattern are formed.

For example, Japan Unexamined Patent Publication No. 2015-000613 discloses a pneumatic tire provided with a decorative section including: a first region connecting a radially inner portion of the tire and a radially outer portion thereof; and a second region with three sides continuously surrounded by radial rib zones and circumferential rib zones. The pneumatic tire disclosed in Japan Unexamined Patent Publication No. 2015-000613 includes ridges provided in at least one of the first region and the second region to contrast patterns between the first region and the second region. Japan Patent No. 5520334 discloses a pneumatic tire having a sidewall section provided in its external surface with a serration section composed of a plurality of small grooves each disposed at an inclination angle of 45° or less with respect to a tire radial direction. The pneumatic tire disclosed in Japan Patent No. 5520334 includes the serration section in which the small grooves each vary in depth between its outermost point and innermost point in the tire radial direction. Japan Unexamined Patent Publication No. 2006-347202 discloses a pneumatic tire including a decorative zone having a first decorative zone and a second decorative zone. The pneumatic tire disclosed in Japan Unexamined Patent Publication No. 2006-347202 includes the first decorative zone having a first segment indication zone in an arc shape with a radius center point provided outside an outer periphery of the pneumatic tire.

The pneumatic tires each repeatedly flex when a load is applied. When the pneumatic tires each are repeatedly deformed, a stress is concentrated at a part of patterns in the decorative section thereof. This may cause a crack to be generated from the part in which the stress is concentrated, as a starting point.

### SUMMARY

The present technology provides a pneumatic tire capable of not only preventing deterioration in the visibility of patterns in a decorative section but also suppressing the growth of a crack even when it has occurred in the decorative section.

A pneumatic tire according to the present technology includes a tread section, a sidewall section, and a bead section. The sidewall section is provided in a predetermined region in a tire radial direction with: a first decorative section provided with a serration section including ridges protruding on an external surface of the sidewall section, the ridges being disposed adjacent to each other in a tire circumferential direction; a second decorative section disposed adjacent to an end portion of the first decorative section in the tire circumferential direction and being provided with a serration section including ridges protruding on the external surface, the ridges being disposed adjacent to each other in the tire circumferential direction; and a recessed section disposed adjacent to the second decorative section and being recessed inward from the second decorative section in the tire radial direction.

The pneumatic tire includes the sidewall section that has the first decorative section, the second decorative section disposed adjacent to the end portion of the first decorative section in the tire circumferential direction, and the recessed section disposed adjacent to the second decorative section and being recessed from the second decorative section. This enables the pneumatic tire not only to be prevented from deteriorating in the visibility of patterns in the decorative section but also to suppress the growth of a crack even when it has occurred in the decorative section.

It is preferable that the first decorative section includes the ridges each having an identical ridge array angle formed with a tangential line of the first decorative section at an inner end edge of the ridge in the tire radial direction, and the second decorative section includes the ridges each having an identical ridge array angle formed with a tangential line of the second decorative section at an inner end edge of the ridge in the tire radial direction, and that an inclination direction of each of the ridges of the first decorative section with respect to a line segment in the tire radial direction is different from an inclination direction of each of the ridges of the second decorative section with respect to the line segment in the tire radial direction. This enables the pneumatic tire not only to be prevented from deteriorating in the visibility of patterns in the decorative section but also to suppress the growth of a crack even when it has occurred in the decorative section.

It is preferable that the sidewall section includes an emblem section provided with a character and/or a figure, and that the emblem section is provided with a plurality of ridges on an external surface of the emblem section. This causes the pneumatic tire to have a further improved visibility of patterns in the decorative section.

It is preferable that the second decorative section includes a plurality of individual second decorative sections divided in the tire radial direction, and that the recessed section is disposed between the plurality of individual second decorative sections. This enables the pneumatic tire not only to be prevented from deteriorating in the visibility of patterns in the decorative section but also to suppress the growth of a crack even when it has occurred in the decorative section.

It is preferable that the second decorative section includes one of the plurality of individual second decorative sections, positioned outside in the tire radial direction, being longer in the tire circumferential direction than one of the plurality of individual second decorative sections, positioned inside in the tire radial direction, and that the one of the plurality of individual second decorative sections, positioned outside in the tire radial direction, projects toward the first decorative section in the tire circumferential direction. This enables the pneumatic tire not only to be prevented from deteriorating in the visibility of patterns in the decorative section but also to suppress the growth of a crack even when it has occurred in the decorative section.

It is preferable that the recessed section is adjacent to an end portion of the second decorative section in the tire circumferential direction that does not face the first decorative section. This enables the pneumatic tire not only to be prevented from deteriorating in the visibility of patterns in the decorative section but also to suppress the growth of a crack even when it has occurred in the decorative section.

It is preferable that the recessed section is disposed between the first decorative section and the second decorative section. This enables the pneumatic tire not only to be prevented from deteriorating in the visibility of patterns in the decorative section but also to suppress the growth of a crack even when it has occurred in the decorative section.

It is preferable that the recessed section is disposed in each of an inner end portion and an outer end portion of the second decorative section in the tire radial direction. This enables the pneumatic tire not only to be prevented from deteriorating in the visibility of patterns in the decorative section but also to suppress the growth of a crack even when it has occurred in the decorative section.

The pneumatic tire of the present technology achieves an effect of enabling not only preventing deterioration in the visibility of patterns in the decorative section but also suppressing the growth of a crack even when it has occurred in the decorative section.

### BRIEF DESCRIPTION OF DRAWINGS

FIG. 1 is a side view of a pneumatic tire according to an embodiment of the present technology.

FIG. 2 is an enlarged side view of a first decorative section, a second decorative section, and a recessed section of the pneumatic tire illustrated in FIG. 1.

FIG. 3 is a cross-sectional view taken along line A-A of FIG. 2.

FIG. 4 is a cross-sectional view taken along line B-B of FIG. 2.

FIG. 5 is an enlarged side view of an emblem section of the pneumatic tire illustrated in FIG. 1.

FIG. 6 is a table showing evaluation test results of pneumatic tires.

### DETAILED DESCRIPTION

Embodiments of the present technology are described in detail below based on the drawings. However, the technology is not limited to these embodiments. Constituents of the embodiments include elements that are essentially identical or that can be substituted or easily conceived by one skilled in the art. Furthermore, the modified examples described in the embodiments can be combined as desired within the scope apparent to one skilled in the art.

Hereinafter, a “tire lateral direction” refers to the direction parallel to a rotation axis (not illustrated) of the pneumatic tire 1, and an “outside in the tire lateral direction” refers to the direction away from a tire equatorial plane (tire equator line) in the tire lateral direction. A “tire circumferential direction” refers to the circumferential direction centered the rotation axis. In addition, a “tire radial direction” refers to the direction orthogonal to the rotation axis, an “inside in the tire radial direction” refers to the direction toward the rotation axis in the tire radial direction, and an “outside in the tire radial direction” refers to the direction away from the rotation axis in the tire radial direction. “Tire equatorial plane” is the plane orthogonal to the rotation axis that passes through the center of the tire width of the pneumatic tire 1. The “tire width” is a width in the tire lateral direction between portions located outside in the tire lateral direction, or a distance between the portions that are the most distant from the tire equatorial plane in the tire lateral direction. The “tire equator line” refers to a line in the circumferential direction of the pneumatic tire 1, on the tire equatorial plane.

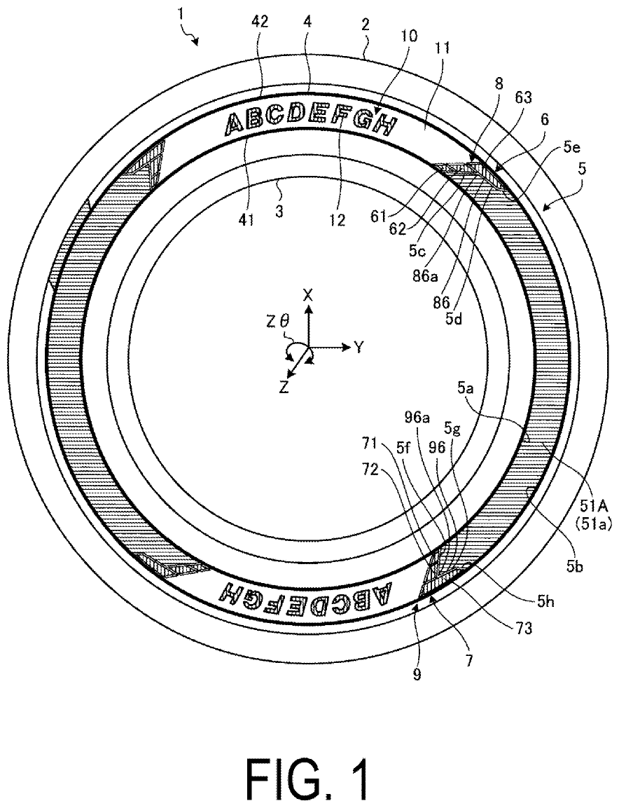

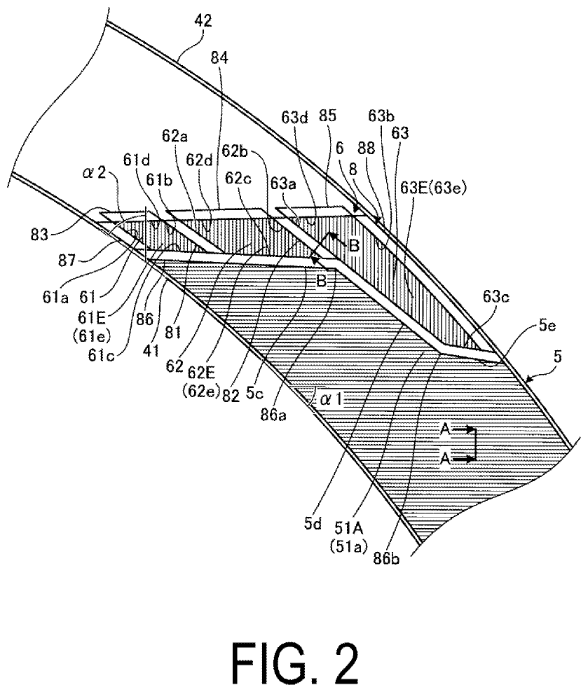

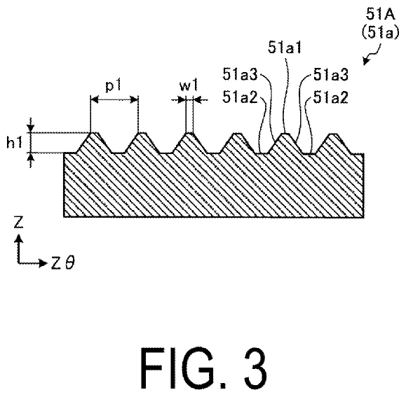

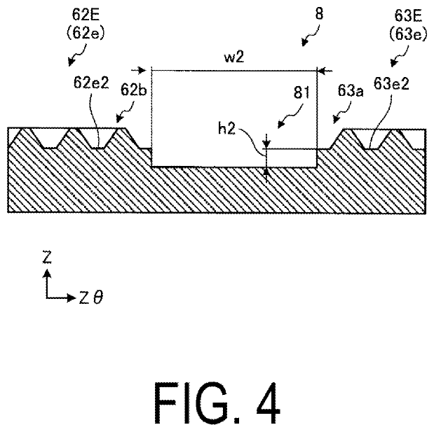

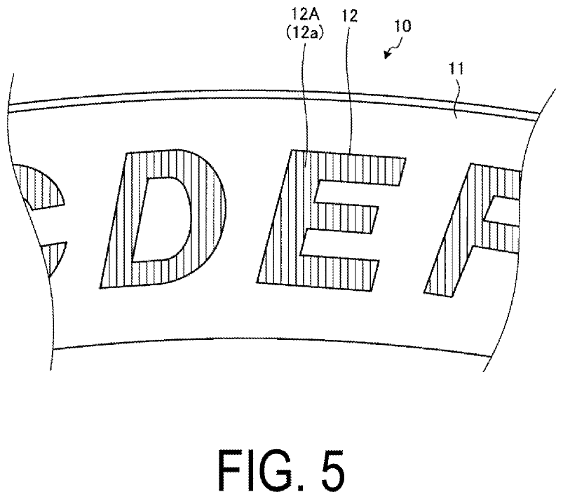

FIG. 1 is a side view of a pneumatic tire according to an embodiment of the present technology. FIG. 2 is an enlarged side view of a first decorative section, a second decorative section, and a recessed section of the pneumatic tire illustrated in FIG. 1. FIG. 3 is a cross-sectional view taken along line A-A of FIG. 2. FIG. 4 is a cross-sectional view taken along line B-B of FIG. 2. FIG. 5 is an enlarged side view of an emblem section of the pneumatic tire illustrated in FIG. 1. As illustrated in FIG. 1, the pneumatic tire 1 includes a tread section 2 that comes into contact with a road surface, a bead section 3 that is fitted into a rim when the pneumatic tire 1 is assembled into the rim to form a rim assembly, and a sidewall section 4 that is visible on the outermost side in the tire lateral direction when the rim assembly is mounted on a vehicle.

The sidewall section 4 is a region interposed between the tread section 2 the bead section 3. The sidewall section 4 is provided with an inner ring 41 and outer ring 42 each of which is an annular ring and extends in the tire circumferential direction. The inner ring 41 and the outer ring 42 each are a circle centered on the center in the tire radial direction. The outer ring 42 is a circle with a diameter greater than that of the inner ring 41. The sidewall section 4 according to the present embodiment is an annular region surrounded by the inner ring 41 and the outer ring 42, being provided in a predetermined region in the tire radial direction at a position on the outermost side in the tire lateral direction, that is, in a region including a position of an end portion (carcass folded-up portion) of a carcass (not illustrated) constituting a framework of the pneumatic tire 1, being folded at the bead section 3, and an overlapping portion of the carcass (carcass splice portion). As illustrated in FIG. 1, the sidewall section 4 includes a first decorative section 5, a second decorative section 6, a second decorative section 7, a recessed section 8, a recessed section 9, and an emblem indication section (decorative section) 10, in the annular region surrounded by the inner ring 41 and the outer ring 42.

More specifically, the pneumatic tire 1 includes the first decorative section 5, the second decorative section 6, the second decorative section 7, the recessed section 8, the recessed section 9, and the emblem indication section 10, each of which is disposed in the sidewall section 4 side by side in the circumferential direction. The pneumatic tire 1 according to the present embodiment includes the sidewall section 4 in which two sets of the first decorative section 5, a pair of the second decorative sections 6 and 7, a pair of the recessed sections 8 and 9, and the emblem indication section 10 are disposed. Specifically, the two first decorative sections 5 are disposed across from one another on either side of the center in the tire radial direction. The first decorative section 5 is provided at its opposite ends in the tire circumferential direction with the second decorative sections 6 and 7. The recessed section 8 is disposed so as to surround the periphery of the second decorative section 6. The recessed section 9 is disposed so as to surround the periphery of the second decorative section 7. The two emblem indication sections 10 each are disposed in a flat portion of the sidewall section 4, between the two sets of the first decorative section 5, the second decorative sections 6 and 7, and the recessed sections 8 and 9. The number of sets of the first decorative section 5, the second decorative sections 6 and 7, the recessed sections 8 and 9, and the emblem indication section 10, being disposed in the sidewall section 4, is not limited to two. The two emblem indication sections 10 each may have a different emblem.

The first decorative region 5 is formed in a shape extending along not only a predetermined range in the sidewall section 4 in the tire radial direction, but also a predetermined range therein in the tire circumferential direction. The first decorative section 5 is formed in a polygonal shape having an outer edge including a side 5a, a side 5b, a side 5c, a side 5d, a side 5e, a side 5f, a side 5g, and a side 5h. The first decorative section 5 is provided with a serration section 51A inside the polygonal shape.

The side 5a is an inner end edge of the first decorative section 5 and extends along the inner ring 41. The side 5b is an outer end edge of the first decorative section 5 and extends along the outer ring 42 at a position facing the outer ring 42. The first decorative section 5 is formed such that the side 5a is connected at one end to one end of the side 5b with the side 5c, the side 5d, and side 5e, and is connected at the other end to the other end of the side 5b with the side 5f, the side 5g, and the side 5h. The side 5c is connected at its inner end in the tire radial direction to the one end of the side 5a, and extends outward in the tire radial direction. The side 5c inclines in a direction approaching the other end of the side 5a toward the outside in the tire radial direction. That is, the side 5c forms an acute angle with the side 5a. The side 5d is connected at its inner end in the tire radial direction to an outer end of the side 5c in the tire radial direction, and extends outward in the tire radial direction. The side 5d inclines in a direction approaching the other end of the side 5a toward the outside in the tire radial direction. The side 5d inclines more toward the side 5a than the side 5c. That is, the side 5d inclines toward a direction closer to the tire circumferential direction than a direction of the side 5c thereto. The side 5e is connected at its inner end in the tire radial direction to an outer end of the side 5d in the tire radial direction, and extends outward in the tire radial direction. The side 5e is connected at its outer end in the tire radial direction to the one end of the side 5b. The side 5e inclines in a direction approaching the other end of the side 5a toward the outside in the tire radial direction. The side 5e inclines more in a direction away from a direction of the side 5a than the side 5d. That is, the side 5d inclines toward a direction closer to the tire radial direction than a direction of the side 5d thereto. The side 5f is connected at its inner end in the tire radial direction portion to the one end of the side 5a, and extends outward in the tire radial direction. The side 5f inclines in a direction away from the one end of the side 5a toward the outside in the tire radial direction. That is, the side 5f forms an obtuse angle with the side 5a. The side 5g is connected at its inner end in the tire radial direction portion to an outer end of the side 5f in the tire radial direction, and extends outward in the tire radial direction. The side 5g inclines in a direction approaching the other end of the side 5a toward the outside in the tire radial direction. The side 5g inclines more toward the side 5a than the side 5f. That is, the side 5g inclines toward a direction closer to the tire circumferential direction than a direction of the side 5f thereto. The side 5h is connected at its inner end in the tire radial direction portion to an outer end of the side 5g in the tire radial direction, and extends toward the outside in the tire radial direction. The side 5h is connected at its outer end in the tire radial direction to the one end of the side 5b. The side 5h inclines in a direction approaching the other end of the side 5a toward the outside in the tire radial direction. The side 5h inclines more in the direction away from the side 5a than the side 5g. That is, the side 5h inclines in a direction closer to the tire radial direction than a direction of the side 5g thereto.

The serration section 51A is formed in the entire area of the first decorative section 5. The serration section 51A includes ridges 51a protruding on the external surface that are disposed adjacent to each other in the tire circumferential direction.

With reference to FIGS. 2 and 3, the ridges 51a will be described. The ridges 51a are protrusions that protrude in the tire lateral direction, and extend in any single direction on the external surface. The ridges 51a are protrusions each in the shape of a mountain ridge extending between an inner periphery of the first decorative section 5 in the tire radial direction and an outer periphery thereof in the tire radial direction. The ridges 51a each have an angle formed with a tangential line of the first decorative section 5 at an inner end edge of the ridge in the tire radial direction, namely an angle (hereinafter referred to as a “ridge array angle”) formed with a tangential line of the side 5a in the tire radial direction, which is an identical angle α1 in the same serration section 51A. It is preferable that the angle α1 is 15° or greater and 60° or less.

The ridges 51a each have a cross-sectional shape taken along a direction orthogonal to its extension direction, protruding on the external surface of the sidewall section 4, or a shape protruding outward in the tire lateral direction. The ridges 51a each include a top face 51a1 that is an outermost portion in the tire lateral direction, a bottom face 51a2 that is an innermost portion in the tire lateral direction, and a side face 51a3 connecting the top face 51a1 and the bottom face 51a2. It is preferable that a distance between the top face 51a1 and the bottom face 51a2, or a depth h1 of the ridge 51a is 0.1 mm or greater and 0.8 mm or less. It is preferable that a width of the top face 51a1, or a width w1 of the ridge 51a is 0.1 mm or greater and 0.8 mm or less. The ridges 51a are disposed at predetermined intervals each of which is a distance p1 (array pitch) between adjacent ridges 51a. It is preferable that the array pitch p1 of the ridges 51a is 0.3 mm or greater and 1.0 mm or less. When the array pitch p1 of the ridges 51a is set within the range described above, the ridges 51a can be disposed at appropriate intervals in the decorative region.

Returning to FIGS. 1 and 2, the structure of each of the second decorative sections 6 and 7 will be described. The second decorative section 6 is disposed adjacent to one end of the first decorative section 5 in the tire circumferential direction. The second decorative section 7 is disposed adjacent to the other end of the first decorative section 5 in the tire circumferential direction. That is, the second decorative section 6 and the second decorative section 7 are disposed at respective ends of one of the first decorative sections 5.

The second decorative section 6 is disposed adjacent to one end of the first decorative section 5 in the tire circumferential direction, or sides 51c, 51d, and 51e. The second decorative section 6 is divided into a plurality of decorative sections in the tire radial direction that are an individual second decorative section 61, an individual second decorative section 62, and an individual second decorative section 63. The present embodiment is configured such that the second decorative section 6 includes the individual second decorative sections 61, 62, and 63 that are disposed in order from inside to outside in the tire radial direction at intervals.

The individual second decorative section 61 is in a rectangular shape having an outer edge including four sides 61a, 61b, 61c, and 61d. The side 61a is a side inside in the tire radial direction, and extends in the tire circumferential direction. The side 61a is disposed outside the inner ring 41 in the tire radial direction while facing the inner ring 41. The side 61b disposed outside the side 61a in the tire radial direction. The side 61b extends in the tire circumferential direction. The side 61b has a length longer than that of the side 61a. The individual second decorative section 61 is configured such that ends of the side 61a and the side 61b are connected to each other with the sides 61c and 61d. The side 61c connects ends of the side 61a and the side 61b on a first decorative section 5 side in the tire circumferential direction, and is disposed adjacent to the side 51c. The side 61d connects ends on the side opposite to the side 61c.

The individual second decorative section 61 is provided in its entire area with a serration section 61E. The serration section 61E is provided with a plurality of ridges 61e protruding that are formed adjacent to each other in the tire circumferential direction. The ridges 61e are similar to the ridges 51a except their forming direction. The ridges 61e each have an inclination direction with respect to the line segment in the tire radial direction, being different from an inclination direction of each of the ridges 51a of the first decorative section 5 with respect to the line segment in the tire radial direction. The ridges 61e extend in a direction different from an extension direction of the ridges 51a. The ridges 61e each have a ridge array angle of an identical angle α2 in the same serration section 61E. It is preferable that the angle α2 is 15° or greater and 60° or less.

The individual second decorative section 62 is in a rectangular shape having an outer edge including four sides 62a, 62b, 62c, and 62d. The side 62a is a side inside in the tire radial direction, and extends in the tire circumferential direction. The side 62a is disposed outside the side 61b in the tire radial direction while facing the side 61b. The side 62b is disposed outside the side 62a in the tire radial direction. The side 62b extends in the tire circumferential direction. The side 62b has a length longer than that of the side 62a. The individual second decorative section 62 is configured such that ends of the side 62a and the side 62b are connected to each other with the sides 62c and 62d. The side 62c connects ends of the side 62a and the side 62b on a first decorative section 5 side in the tire circumferential direction, and is disposed adjacent to the side 51c. The side 62d connects ends on the side opposite to the side 62c. The side 62c is disposed on a line segment extending outward in the tire radial direction from the side 61c. The side 62d is disposed on a line segment extending outward in the tire radial direction from the side 61d.

The individual second decorative section 62 is provided in its entire area with a serration section 62E. The serration section 62E is configured as with the serration section 61E, and is provided with a plurality of ridges 62e protruding that are formed adjacent to each other in the tire circumferential direction. The ridges 62e are configured as with the ridges 61e.

The individual second decorative section 63 projects more toward the first decorative section 5 in the tire circumferential direction than the individual second decorative sections 61 and 62. The individual second decorative section 63 is in a rectangular shape having an outer edge including four sides 63a, 63b, 63c, and 63d. The side 63a is a side inside in the tire radial direction, and extends in the tire circumferential direction. The side 63a is disposed outside the side 62b in the tire radial direction while a part of the side 63a faces the side 62b. The side 63a is disposed outside the side 5d in the tire radial direction while a part of the side 63a also faces the side 5d. The side 63b is disposed outside the side 63a in the tire radial direction. The side 63b extends in the tire circumferential direction. The side 63b has a length longer than that of the side 63a. The individual second decorative section 63 is configured such that ends of the side 63a and the side 63b are connected to each other with the sides 63c and 63d. The side 63c connects ends of the side 63a and the side 63b on a first decorative section 5 side in the tire circumferential direction, and is disposed adjacent to the side 51e. The side 63d connects ends on the side opposite to the side 63c.

The individual second decorative section 63 is provided in its entire area with a serration section 63E. The serration section 63E is configured as with the serration section 61E, and is provided with a plurality of ridges 63e protruding that are formed adjacent to each other in the tire circumferential direction. The ridges 63e are configured as with the ridges 61e.

The second decorative section 7 is disposed adjacent to the other end of the first decorative section 5 in the tire circumferential direction. The second decorative section 7 is configured as with the second decorative section 6 so as to be divided into a plurality of decorative sections in the tire radial direction that are an individual second decorative section 71, an individual second decorative section 72, and an individual second decorative section 73. The individual second decorative section 71 has a shape similar to that of the individual second decorative section 61. The individual second decorative section 72 has a shape similar to that of the individual second decorative section 62. The individual second decorative section 73 has a shape similar to that of the individual second decorative section 63.

The recessed section 8 is disposed adjacent to the second decorative section 6. The recessed section 8 is recessed inward in the tire radial direction from the second decorative section 6. The recessed section 8 includes a first recessed section 81, a second recessed section 82, a third recessed section 83, a fourth recessed section 84, a fifth recessed section 85, a sixth recessed section 86, a seventh recessed section 87, and an eighth recessed section 88.

The first recessed section 81 is disposed between the individual second decorative section 61 and the individual second decorative section 62. More specifically, the first recessed section 81 is disposed between the side 61b and the side 62a. The second recessed section 82 is disposed between the individual second decorative section 62 and the individual second decorative section 63. More specifically, the second recessed section 82 is disposed between the side 62b and the side 63a. The third recessed section 83 is adjacent to an end portion of the individual second decorative section 61 in the tire circumferential direction that does not face the first decorative section 5, namely, to the side 61d. The fourth recessed section 84 is adjacent to an end portion of the individual second decorative section 62 in the tire circumferential direction that does not face the first decorative section 5, namely, to the side 62d. The fourth recessed section 84 is disposed at a position on a line segment extending outward in the tire radial direction from the third recessed section 83. The fifth recessed section 85 is adjacent to an end portion of the individual second decorative section 63 in the tire circumferential direction that does not face the first decorative section 5, namely, to the side 63d. The fifth recessed section 85 is disposed at a position on a line segment extending outward in the tire radial direction from the third recessed section 83.

The sixth recessed section 86 is disposed between the first decorative section 5 and the second decorative section 6. The sixth recessed section 86 includes a bent portion 86a and a bent portion 86b. The sixth recessed section 86 has an obtuse angle at the bent portion 86a. The sixth recessed section 86 is disposed between the sides 61c, 62c, a part of side 63a, the side 63c, and the sides 5c, 5d, and 5e.

The seventh recessed section 87 is disposed between the individual second decorative section 61 and the inner ring 41. More specifically, the seventh recessed section 87 is disposed adjacent to the side 61a. The eighth recessed section 88 is disposed between the individual second decorative section 63 and the outer ring 42. More specifically, the eighth recessed section 88 is disposed adjacent to the side 63b.

Next, the first recessed section 81 will be described with reference to FIG. 4. The first recessed section 81, the second recessed section 82, the third recessed section 83, the fourth recessed section 84, the fifth recessed section 85, the sixth recessed section 86, the seventh recessed section 87, and the eighth recessed section 88 each basically have a similar structure, so that the first recessed section 81 will be described below as a representative. The first recessed section 81 has a cross-sectional shape taken along a direction orthogonal to its extension direction, being recessed in the external surface of the sidewall section 4, or a shape recessed inward in the tire lateral direction. It is preferable that the first recessed section 81 has a depth h2 of 0 mm or greater and 0.5 mm or less, and a depth h2 of greater than 0 mm and 0.5 mm or less is more preferable. It is preferable that the first recessed section 81 has a width w2 of 2 mm or greater and 5 mm or less. The first recessed section 81 is recessed inward in the tire radial direction from a bottom face 62e2 of the ridge 62e, and a bottom face 63e2 of the ridge 63e.

The recessed section 9 is disposed adjacent to the second decorative section 7. The recessed section 9 is configured as with the recessed section 8. The recessed section 9 includes a first recessed section 91, a second recessed section 92, a third recessed section 93, a fourth recessed section 94, a fifth recessed section 95, a sixth recessed section 96, a seventh recessed section 97, and an eighth recessed section 98. The first recessed section 91, the second recessed section 92, the third recessed section 93, the fourth recessed section 94, the fifth recessed section 95, the sixth recessed section 96, the seventh recessed section 97, and the eighth recessed section 98 are similar in shape to the first recessed section 81, the second recessed section 82, the third recessed section 83, the fourth recessed section 84, the fifth recessed section 85, the sixth recessed section 86, the seventh recessed section 87, and the eighth recessed section 88, respectively, so that descriptions thereof are eliminated. The sixth recessed section 86 includes a bent portion 96a. The sixth recessed section 96 has an acute angle at the bent portion 96a.

The emblem indication section 10 includes a flat portion 11, and an emblem section 12 for characters and figures indicating a brand name and a size for identifying a tire. The emblem section 12 expresses a character and a figure with a shape of protrusions and a shape of recesses formed in the flat portion 11. The shape of protrusions and the shape of recesses formed in the flat portion 11 may be formed by juxtaposing protrusions each extending in one direction, such as the ridges described above, and the character may be expressed by adjusting a length of each of the ridges.

The emblem section 12 is provided in its external surface with a serration section 12A. The serration section 12A includes ridges 12a protruding on the external surface that are disposed adjacent to each other in the tire circumferential direction. The ridges 12a are similar to the ridges 51a except their forming direction. The ridges 12a each have an inclination direction with respect to the line segment in the tire radial direction, being different from an inclination direction of each of the ridges 51a, 61e, 62e, 63e, 71e, 72e, and 73e with respect to the line segment in the tire radial direction. The ridges 12a extend in a direction different from an extension direction of each of the ridges 51a, 61e, 62e, 63e, 71e, 72e, and 73e. The ridges 12a each have a ridge array angle of an identical angle α3 in the same serration section 12A. It is preferable that the angle α3 is 90°. The ridges 12a extend in the tire radial direction.

The pneumatic tire 1 has a structure as described above in which each of the emblem indication sections 10 is interposed between the two sets of the first decorative section 5, the pair of second decorative sections 6 and 7, and the pair of recessed sections 8 and 9, in the tire circumferential direction. This enables the pneumatic tire 1 to have an improved visibility of the emblem section 12 of each of the emblem indication sections 10. Each of the emblem indication sections 10 includes the emblem section 12 disposed in the flat portion 11 in a flat shape, so that the visibility of the emblem section 12 can be further improved. In addition, the first decorative section 5, the second decorative sections 6 and 7, and the emblem section 12 are respectively provided with the ridges 51a, the ridges 61e, 62e, 63e, 71e, 72e, and 73e, and the ridges 12a, which are different in inclination direction with respect to the line segment in the tire radial direction. This enables the pneumatic tire 1 to have a further improved visibility of the emblem section 12 of each of the emblem indication sections 10.

The pneumatic tire 1 is configured such that each of the emblem indication sections 10 is interposed between the two sets of the first decorative section 5, the pair of second decorative sections 6 and 7 disposed adjacent to respective ends of the first decorative section 5 in the tire circumferential direction, and the pair of recessed sections 8 and 9 disposed adjacent to the second decorative sections 6 and 7, respectively, in the tire circumferential direction. The first decorative section 5 and the second decorative sections 6 and 7 are respectively provided with the ridges 51a, and the ridges 61e, 62e, 63e, 71e, 72e, and 73e, which are different in inclination direction with respect to the line segment in the tire radial direction. In addition, the recessed sections 8 and 9 are respectively disposed: between the first decorative section 5 and the second decorative sections 6 and 7; among the individual second decorative sections 61, 62, and 63, and among the individual second decorative section 71, 72, and 73; and between the second decorative sections 6 and 7 and the corresponding emblem indication sections 10, or in end portions of the respective second decorative sections 6 and 7 in the tire radial direction. As a result, even when a crack generated in an end portion of the first decorative section 5 in the tire circumferential direction grows, for example, the corresponding one of the second decorative sections 6 and 7, and the corresponding one of the recessed sections 8 and 9, prevent the crack from further growing toward the corresponding one of the emblem indication sections 10. This causes the pneumatic tire 1 to prevent a crack from growing to reach the emblem indication section 10.

As described above, the pneumatic tire 1 can not only be prevented from deteriorating in the visibility of patterns in the emblem indication section 10 as a decorative section, but also suppress the growth of a crack even when it has occurred.

While there is described the pneumatic tire 1 according to the present embodiment that is provided with the three individual second decorative sections 61, 62, and 63, and the three individual second decorative sections 71, 72, and 73, the number of the individual second decorative sections is not limited thereto.

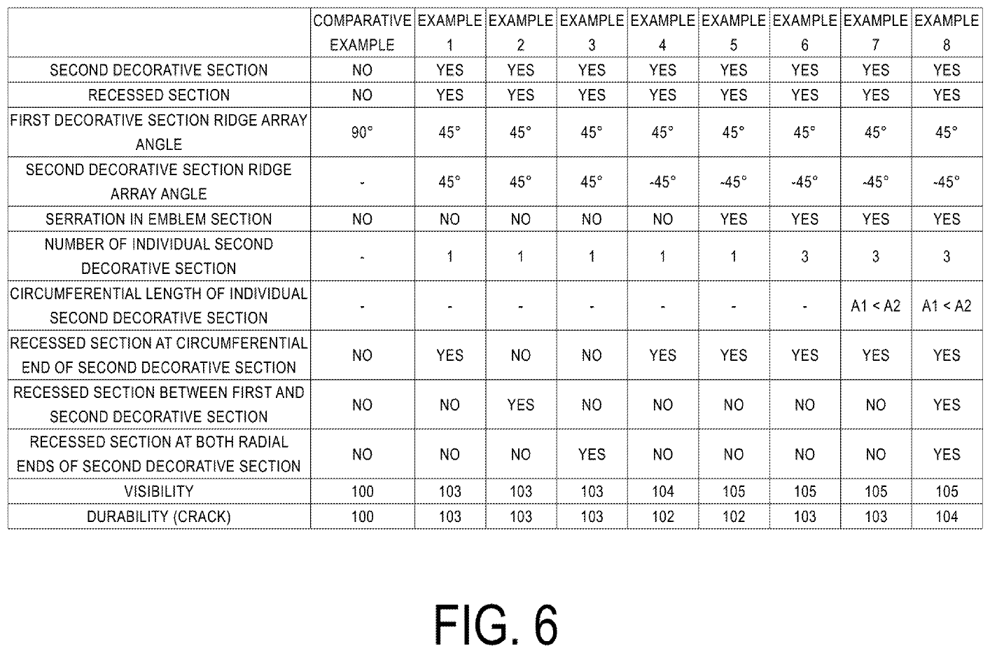

Next, the pneumatic tire is described in further detail using test examples. The present test examples each used a pneumatic tire having a tire size of 275/45R20 110V and a rim size of 20×9.5J. The present test examples used the pneumatic tire provided with ridges each of which has a depth h1 of 0.3 mm and a width w1 of 0.3 mm, and which are disposed at an array pitch p1 of 0.7 mm. The pneumatic tire 1 having the size described above was provided with the sidewall section 4 in which the first decorative section 5, the second decorative sections 6 and 7, the recessed sections 8 and 9, and the emblem indication section 10, were formed as a decorative region of each of the Comparative examples and the Examples, and then was evaluated for various evaluation items. FIG. 6 shows evaluation test results of pneumatic tires.

The present test examples included Comparative Example that used a pneumatic tire in which the second decorative sections 6 and 7, and the recessed sections 8 and 9, were not provided. The first decorative section 5 had a ridge array angle α1 of 90°, and the emblem indication section 10 was provided with no ridge.

The present test examples included pneumatic tires of Examples 1 to 8 that were evaluated as Examples. The pneumatic tire of Example 1 was configured as follows: the second decorative sections 6 and 7, the recessed sections 8 and 9, were provided; the first decorative section 5 had a ridge array angle α1 of 45° and the second decorative sections 6 and 7 each had a ridge array angle α2 of 45°; the emblem indication section 10 was provided with no ridge; the second decorative sections 6 and 7 included the individual second decorative sections 61 and 71, respectively; and the second decorative sections 6 and 7 were provided in their end portions in the tire circumferential direction with the recessed sections 8 and 9, respectively, and other recessed sections 8 and 9 were not provided. More specifically, the pneumatic tire of Example 1 was configured such that the third recessed sections 83 and 93, the fourth recessed sections 84 and 94, and the fifth recessed sections 85 and 95, were provided, and such that the first recessed sections 81 and 91, the second recessed sections 82 and 92, the sixth recessed sections 86 and 96, the seventh recessed sections 87 and 97, and the eighth recessed sections 88 and 98, were not provided.

The pneumatic tire of Example 2 was configured such that each of the recessed sections 8 and 9 was provided between the first decorative section 5 and the corresponding one of the second decorative sections 6 and 7, and such that other recessed sections 8 and 9 were not provided. More specifically, the pneumatic tire of Example 2 was configured such that the sixth recessed sections 86 and 96 were provided, and such that the first recessed sections 81 and 91, the second recessed sections 82 and 92, the third recessed sections 83 and 93, the fourth recessed sections 84 and 94, the fifth recessed sections 85 and 95, the seventh recessed sections 87 and 97, and the eighth recessed sections 88 and 98, were not provided. The other conditions were the same as those of the pneumatic tire of Example 1.

The pneumatic tire of Example 3 was configured such that the second decorative sections 6 and 7 were provided in their end portions in the tire radial direction with the recessed sections 8 and 9, respectively, and such that the recessed sections 8 and 9 were not provided in another place. More specifically, the pneumatic tire of Example 3 was configured such that the seventh recessed sections 87 and 97, and the eighth recessed sections 88 and 98, were provided, and such that the first recessed sections 81 and 91, the second recessed sections 82 and 92, the third recessed sections 83 and 93, the fourth recessed sections 84 and 94, the fifth recessed sections 85 and 95, and the sixth recessed sections 86 and 96, were not provided. The other conditions were the same as those of the pneumatic tire of Example 1.

The pneumatic tire of Example 4 was configured such that the second decorative sections 6 and 7 each had a ridge array angle α2 of −45°. The other conditions were the same as those of the pneumatic tire of Example 1.

The pneumatic tire of Example 5 was configured such that the emblem indication section 10 was provided with ridges. The other conditions were the same as those of the pneumatic tire of Example 4.

The pneumatic tire of Example 6 was configured such that the second decorative sections 6 and 7 included the three individual second decorative sections 61, 62, and 63, and 71, 72, and 73, respectively. The other conditions were the same as those of the pneumatic tire of Example 5.

The pneumatic tire of Example 6 was configured such that the individual second decorative sections 61, 62, and 63 and 71, 72, and 73, each of which had a length in the tire circumferential direction, the length being increased in the order of the individual second decorative sections 61, 62, and 63 and 71, 72, and 73. The other conditions were the same as those of the pneumatic tire of Example 6.

The pneumatic tire of Example 8 was configured as follows: the second decorative sections 6 and 7, and the recessed sections 8 and 9 were provided; the first decorative section 5 had a ridge array angle α1 of 45° and the second decorative sections 6 and 7 each had a ridge array angle α2 of −45°; the emblem indication section 10 was provided with ridges; the second decorative sections 6 and 7 included the three individual second decorative sections 61, 62, and 63, and the three individual second decorative sections 71, 72, and 73, respectively; and there were provided the first recessed section 81 and 91, the second recessed sections 82 and 92, the third recessed sections 83 and 93, the fourth recessed sections 84 and 94, the fifth recessed sections 85 and 95, the sixth recessed sections 86 and 96, the seventh recessed sections 87 and 97, and the eighth recessed sections 88 and 98.

In the present test examples, the pneumatic tire of each of Comparative Example and Examples described above was evaluated for two items of visibility and durability (suppression of crack growth). The visibility was visually evaluated for a conspicuous level of the emblem section of the emblem indication section in the sidewall section. The evaluation results each were expressed as an index value when the evaluation result of the pneumatic tire of Comparative Example was indicated as 100. Larger index values indicate superior durability of the emblem section of the emblem indication section in the sidewall section. Durability is the durability of the sidewall section against cracking. In the present test examples, the vicinity of an end portion (a range within 50 mm from the end portion) of the first decorative section in the tire circumferential direction, in the sidewall section, was visually evaluated for occurrence and growth of a crack. The crack having a width of 1.5 mm or greater, and a length of 5 mm or greater was counted as one crack. Each of the pneumatic tires filled with air under a pressure of 100 kPa was caused to continuously travel at a speed of 80 km/h for 50 hours by using an indoor drum tester while a load of 4.5 kN was loaded, and ozone of a concentration of 100 pphm was discharged to the external surface of the sidewall section at a distance of 10 mm. Then, each of the pneumatic tires having travelled was evaluated by measuring the number of cracks having occurred. The evaluation results each were expressed as an index value with the number of occurrence of a crack of the pneumatic tire of Comparative Example being assigned the value 100. Larger index values indicate superior durability, and specifically indicate that crack growth was further suppressed.

As shown in FIG. 6, it was found that each of the Examples had higher evaluation for each of the two items than the Conventional Example. As described above, it is found that the pneumatic tire of the present technology can not only be prevented from deteriorating in the visibility of patterns in the decorative section, but also suppress the growth of a crack even when it has occurred in the decorative section.

1. A pneumatic tire comprising:
a tread section;
a sidewall section; and
a bead section,
the sidewall section being provided in a predetermined region in a tire radial direction with:
a first decorative section provided with a serration section including ridges protruding on an external surface of the sidewall section, the ridges being disposed adjacent to each other in a tire circumferential direction;
a second decorative section disposed adjacent to an end portion of the first decorative section in the tire circumferential direction and being provided with a serration section including ridges protruding on the external surface, the ridges being disposed adjacent to each other in the tire circumferential direction; and
a recessed section disposed adjacent to the second decorative section and being recessed inward from the second decorative section in the tire radial direction.

2. The pneumatic tire according to claim 1, wherein
the first decorative section includes the ridges each having an identical ridge array angle formed with a tangential line of the first decorative section at an inner end edge of the ridge in the tire radial direction;
the second decorative section includes the ridges each having an identical ridge array angle formed with a tangential line of the second decorative section at an inner end edge of the ridge in the tire radial direction; and
an inclination direction of each of the ridges of the first decorative section with respect to a line segment in the tire radial direction is different from an inclination direction of each of the ridges of the second decorative section with respect to the line segment in the tire radial direction.

3. The pneumatic tire according to claim 1, wherein
the sidewall section includes an emblem section provided with a character and/or a figure; and
the emblem section is provided with ridges on an external surface of the emblem section.

4. The pneumatic tire according to claim 1, wherein
the second decorative section includes a plurality of individual second decorative sections divided in the tire radial direction; and
the recessed section is disposed between the plurality of individual second decorative sections.

5. The pneumatic tire according to claim 4, wherein
the second decorative section includes one of the plurality of individual second decorative sections, positioned outside in the tire radial direction, being longer in the tire circumferential direction than one of the plurality of individual second decorative sections, positioned inside in the tire radial direction; and
the one of the plurality of individual second decorative sections, positioned outside in the tire radial direction, projects toward the first decorative section in the tire circumferential direction.

6. The pneumatic tire according to claim 1, wherein
the recessed section is adjacent to an end portion of the second decorative section in the tire circumferential direction that does not face the first decorative section.

7. The pneumatic tire according to claim 1, wherein
the recessed section is disposed between the first decorative section and the second decorative section.

8. The pneumatic tire according to claim 1, wherein
the recessed section is disposed in each of an inner end portion and an outer end portion of the second decorative section in the tire radial direction.

9. The pneumatic tire according to claim 2, wherein
the sidewall section includes an emblem section provided with a character and/or a figure; and
the emblem section is provided with ridges on an external surface of the emblem section.

10. The pneumatic tire according to claim 9, wherein
the second decorative section includes a plurality of individual second decorative sections divided in the tire radial direction; and
the recessed section is disposed between the plurality of individual second decorative sections.

11. The pneumatic tire according to claim 10, wherein
the second decorative section includes one of the plurality of individual second decorative sections, positioned outside in the tire radial direction, being longer in the tire circumferential direction than one of the plurality of individual second decorative sections, positioned inside in the tire radial direction; and
the one of the plurality of individual second decorative sections, positioned outside in the tire radial direction, projects toward the first decorative section in the tire circumferential direction.

12. The pneumatic tire according to claim 11, wherein
the recessed section is adjacent to an end portion of the second decorative section in the tire circumferential direction that does not face the first decorative section.

13. The pneumatic tire according to claim 12, wherein
the recessed section is disposed between the first decorative section and the second decorative section.

14. The pneumatic tire according to claim 13, wherein
the recessed section is disposed in each of an inner end portion and an outer end portion of the second decorative section in the tire radial direction.
